(19) United States
(12) Patent Application Publication
(10) Pub. No.: US 2003/0162866 A1
(43) Pub. Date: Aug. 28, 2003

(54) Compositions based on phenolic derivatives and their use as mineral binder additives

(76) Inventors: Evelyne Prat, Pantin (FR); Mustapha Sari, Villeurbanne (FR); Dominique Hebrault, Lyon (FR)

Correspondence Address: Rhonia Inc, Intellectual Property Department, 259 Prospect Plains Road, CN 7500, Cranbury, NJ, 08512-7500, US

(21) Appl. No.: 10/182,071

(22) PCT Filed: Jan. 29, 2001
(86) PCT No.: PCT/FR01/00268

(51) Int. Cl. C08K 3/00

(52) U.S. Cl. 524/2

(57) ABSTRACT

The invention concerns a composition based on phenolic derivatives and their use as mineral binder additives, enabling to obtain mineral matrices, preferably of mortars and concrete mixtures, with improved properties. The invention also concerns a composition for binders, in the form of a powder or an aqueous suspension, comprising at least a phenolic derivative and at least a polymer. The invention further concerns methods for preparing those various compositions, and their uses in particular for making mortars and concrete mixtures.

The present invention relates to compositions based on phenolic derivatives and their use as mineral binder adjuvants, for obtaining mineral matrices, preferably mortars and concretes, with improved properties.

The invention also relates to a binder composition, in the form of a powder or an aqueous suspension, comprising at least one phenolic-derivative additive and at least one amorphous silica.

The invention also relates to a binder composition, in the form of a powder or an aqueous suspension, comprising at least one phenolic derivative and at least one polymer.

The invention also relates to processes for preparing these various compositions, and to their uses especially for manufacturing mortars and concretes.

It is known that mortars and concretes are prepared by mixing mineral binders, preferably a cement, with water and granulates, for instance sand and gravel.

The expression “mineral binders” denotes products such as, for example, cement (or lime) that are capable of setting and hardening in the presence of water with formation of stable compounds.

Although it is customary for a specialist to term as a “concrete” a composition in which the mineral charge is based on relatively coarse granulates (of the order of 5 to 30 mm), and as “mortar” a composition in which the mineral charge is based on finer granulates, the term “concrete” will be used without discrimination in the present description to denote all types of compositions, irrespective of the particle size, in order to simplify the description.

Still for the purposes of simplifying the description, in the context of the present invention, the term “concrete” will denote, by extension, cement matrices that are compositions free of sand and granulates, and containing cement and, optionally, charges of filler type (calcium carbonate, fly ash, slag, etc.).

By extension, the invention also applies to bonding mortars, leveling plaster coats, resurfacing plaster coats, repair mortars, self-leveling mortars, etc.

Freshly prepared concrete, which will be left to harden once in place, must remain stable for as long as it is not in use.

The problem then arises especially of the workability, in terms of maintaining a suitable level of fluidity.

This problem arises all the more frequently since concrete, which can admittedly be manufactured as and when needed at the site of use, is more and more frequently manufactured at a ready-mix plant, and then conveyed to the site of use. It is then important for the concrete to have a suitable setting time, and to maintain its stability and all its properties during the traveling time.

Among the various properties, the fluidity, which conditions the ease of use of the concrete, is an essential property.

To obtain these fluidity properties, superplasticizing additives are generally added to the concrete, such as condensates of naphthalenesulfonate or melaminesulfonate type, of alkali metal and alkaline-earth metal polycarboxylate type; alkali metal and alkaline-earth metal polyacrylates; polyalkylene oxides optionally grafted with a calcium-complexing group or derivatives thereof, optionally in combination with an aminoalkylene phosphonate; polymer or copolymer derivatives based on acrylic or methacrylic acid, and terpolymers of acrylic or methacrylic acid or salts thereof.

Another important property is the cohesion of the concrete. The expression “cohesion of the concrete” means, inter alia, its pumpability when it is fluid concrete, its plasticity when greater ease of use and a better surface appearance are desired, or its rebound when it is sprayed concrete.

With the aim of maintaining and/or improving the stability and properties, especially the fluidity and the cohesion, suitable additives are usually incorporated into concretes. However, it is not uncommon for the additives to give, when they are added separately from each other and/or successively, along with the positive effect for which they are used, a harmful effect on other properties.

Thus, an agent for improving the fluidity of concrete, at high contents that are occasionally necessary to achieve the desired result, may very markedly degrade the cohesion of the concrete and, for example, have a negative effect on the pumpability (for example in the case of fluid concretes).

Moreover, it may also, at high doses, entrain large amounts of air, which is reflected by a degradation in the mechanical properties, and induce delays in setting, which immobilizes the shuttering for long periods, thus limiting the progress of the building sites.

It has now been found, and this is the subject of the present invention, that the addition of an effective amount of a phenolic derivative to a cement matrix, preferably concrete, makes it possible to obtain advantageous properties.

Thus, it has been demonstrated that the addition of a small amount of phenolic derivative, preferably less than 0.5% relative to the weight of cement, can fluidize concrete compositions without entraining air, thus giving concrete compositions that are both dense and fluid, which is not the case with the abovementioned superplasticizers, which entrain air.

Furthermore, the presence of the phenolic derivative gives, unexpectedly, concretes that display at a young age high mechanical characteristics (tensile strength by bending and in simple compression), unlike the common superplasticizers, which delay the acquisition of mechanical performance qualities at a young age.

In addition, it has been found that by advantageously combining an adjuvant of phenolic derivative type and a silica that is preferably amorphous, in the form of an aqueous suspension, the concrete prepared is given improved cohesion, especially by increasing the pumpability and the plasticity when said composition is incorporated into a fluid concrete, or by reducing the rebound when it is introduced into sprayed concrete.

Finally, it has been found that the combination of a phenolic derivative and a polymer in applications using it makes it possible to obtain improved properties such as better adhesion and water resistance.

Phenolic Derivatives

The essential constituent forming part of the cement compositions of the invention is a phenolic derivative.

The expression “phenolic derivative” means any aromatic and preferably benzenic compound bearing at least one hydroxyl group in free or functionalized form and bearing at least one other group comprising an oxygen and/or nitrogen and/or sulfur and/or phosphorus atom: said group possibly being borne by the aromatic ring, by a side chain borne by the ring or alternatively forming part of the group attached to the oxygen atom.

The phenolic derivatives preferentially used correspond more particularly to formula (I):

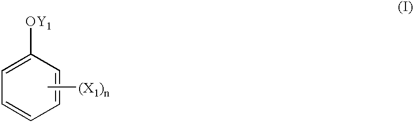

in said formula (I):

—Y₁ represents:

a hydrogen atom,

a linear or branched alkyl group containing from 1 to 12 carbon atoms and preferably from 1 to 4 carbon atoms,

an acyl group of formula R₃—CO— in which R₃ represents a linear or branched alkyl group containing from 1 to 17 carbon atoms,

a group R which may be a linear or branched alkyl group containing from 1 to 12 carbon atoms or an alkenyl or alkynyl group containing from 2 to 12 carbon atoms bearing an ionizable group G in acid or salified form, such as a carboxylic, carboxylate, sulfonic, sulfonate, hemisulfuric, sulfate, phosphonic, phosphonate, hemiphosphoric or phosphate group in acid or salified form,

a group of formula (F):

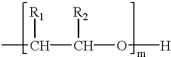

(F) in which the groups R₁ and R₂, which may be identical or different, represent a hydrogen atom or a methyl or ethyl group: when one of the groups R₁ or R₂ is a methyl or ethyl group, the other group R₁ or R₂ is then a hydrogen atom and m is a number between 1 and 50;

X₁ represents:

a hydroxyl group,

an ionizable group G in acid or salified form, such as a carboxylic, carboxylate, sulfonic, sulfonate, hemisulfuric, sulfate, phosphonic, phosphonate, hemiphosphoric or phosphate group in acid or salified form,

a group R which may be a linear or branched alkyl group containing from 1 to 12 carbon atoms or an alkenyl or alkynyl group containing from 2 to 12 carbon atoms bearing an ionizable group G in acid or salified form, such as a carboxylic, carboxylate, sulfonic, sulfonate, hemisulfuric, sulfate, phosphonic, phosphonate, hemiphosphoric or phosphate group in acid or salified form,

a group —O—Y₂, Y₂, which may be identical to or different than Y₁, having the same meaning,

a linear or branched alkyl group containing from 1 to 18 carbon atoms, preferably methyl, ethyl, propyl, isopropyl, butyl, isobutyl, sec-butyl, tert-butyl, dodecyl, hexadecyl or octadecyl;

a linear or branched alkenyl group containing from 2 to 6 carbon atoms and preferably from 2 to 4 carbon atoms, such as vinyl or allyl,

a linear or branched alkoxy group containing from 1 to 6 carbon atoms and preferably from 1 to 4 carbon atoms, such as methoxy, ethoxy, propoxy, isopropoxy or butoxy groups, an alkenyloxy group, preferably an allyloxy group or a phenoxy group,

an acyl group of formula R₃—CO— in which R₃ represents a linear or branched alkyl group containing from 1 to 17 carbon atoms, preferably acetyl, lauroyl, palmitoyl or stearoyl,

an ═O group,

a —CHOH—COOH group,

a group of formula:

—R₄—OH

—R₄—CHO

—R₄—NO₂

—R₄—NH₂

—R₄—CO—NH₂

—R₄—NH—CH₂—CH₂—OH

—R₄—N—[CH₂—CH₂—OH]₂

—R₄—NH—CH₂—CO₂H

—R₄—N—[CH₂—CO₂H]₂

in said formulae, R₄ represents a valency bond or a linear or branched, saturated or unsaturated divalent hydrocarbon group containing from 1 to 6 carbon atoms such as, for example, methylene, ethylene, propylene, isopropylene or isopropylidene; the groups R₅, which may be identical or different, represent a hydrogen atom, a linear or branched alkyl group containing from 1 to 6 carbon atoms, or a metal cation, preferably an alkali metal cation or an ammonium group,

if n is equal to 0, Y₁ represents a group R,

if Y₁ represents a hydrogen atom, n is at least equal to 1,

n is a number ranging from 0 to 5 and preferably equal to 1, 2 or 3.

Phenolic derivatives corresponding to formula (I) in which the group Y₁ represents a hydrogen atom are featured according to the invention. In this case, X₁ more particularly represents a formyl group or a carboxylic group.

When the phenolic derivatives correspond to formula (I) in which the hydroxyl group is converted to an oxyalkylenated group as represented by formula (F), the group R₂ preferentially represents a hydrogen atom or a methyl group and the group R₁ represents a hydrogen atom.

The number of oxyalkylenated units can vary widely between 1 and 50, but is preferably between 1 and 20.

The invention is also directed toward phenolic derivatives comprising several types of oxyalkylenated units, in particular oxyethylenated units and oxypropylenated units: said units are distributed randomly or in block form.

They are more preferentially represented by formula (I) in which Y₁ represents a group of formula (F₁):

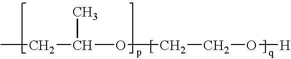

in which p and q are numbers such that:

p+q=m,

p+q≠1

p is between 0 and 5,

q is between 0 and 10

The invention is directed toward oxyalkylenated phenolic derivatives corresponding to formula (I), in which X₁ represents one or two sulfonic groups in salified form, preferably in the form of an alkali metal (preferentially sodium or potassium), an alkaline-earth metal or an ammonium group.

Such compounds that may be used according to the invention are described in patent applications FR 98/04918 and 98/04919.

Phenolic derivatives corresponding to formula (I) in which the group Y₁ represents a functionalized group symbolized by the group R which is an alkyl, alkenyl or alkynyl group bearing an ionizable group, are featured according to the invention. The invention does not exclude the group R as defined from being interrupted with an oxygen or nitrogen hetero atom or with a functional group such as carbonyl, carboxyl, amino, amido, sulfone, etc.

It should be noted that when n is equal to 0 , X₁ represents a group of the type R comprising an ionizable group.

As more specific examples of phenolic derivatives that are entirely suitable for carrying out the invention, mention may be made especially of the following families of compounds: diphenolic compounds, vanillin precursors and derivatives, salicylic compounds and nitrogenous phenolic compounds.

Examples of phenolic derivatives that may be used as adjuvants for binders, preferably mortars and concretes, are given below:

phenoxyacetic acid,

diphenolic compounds,

pyrocatechin,

resorcinol,

1,4-bis(2-hydroxyethoxy)benzene,

1,3-bis(2-hydroxyethoxy)benzene,

1,2-bis(2-hydroxyethoxy)benzene,

sodium 4,5-dihydroxybenzene-1,3-disulfonate (TIRON),

sodium 2,5-dihydroxybenzene- 1,4-disulfonate,

sodium 4,5-bis(2-hydroxyethoxy)benzene-1,3-disulfonate,

sodium 4,5-bis(2-hydroxy-1-propoxy)benzene-1,3-disulfonate,

sodium 4,6-bis(2-hydroxyethoxy)benzene-1,3-disulfonate,

3,4-dihydroxybenzaldehyde,

2,5-dihydroxybenzoquinone,

2,6-dinitro-4-methoxyphenol,

4-amino-1,2-dihydroxybenzene,

2,3-dihydroxybenzaldehyde,

2,4-dihydroxybenzaldehyde,

2,5-dihydroxybenzaldehyde,

3,4-dihydroxybenzaldehyde,

2,6-dihydroxybenzaldehyde,

3,5-dihydroxybenzaldehyde,

3,4-dihydroxybenzoic acid,

2-hydroxyphenoxyacetic acid,

nitrogenous phenolic compounds,

2-aminophenol,

3-aminophenol,

2-amino-1-(2-hydroxyethoxy)benzene,

3-amino-1-(2-hydroxyethoxy)benzene,

2-amino-o-cresol,

3-amino-o-cresol,

6-amino-m-cresol,

vanillin precursors,

guetol,

vanillomandelic acid,

orthovanillomandelic acid,

catecholmandelic acid,

methylenedioxybenzenemandelic acid,

p-trifluoromethylmandelic acid,

2,6-difluoromandelic acid,

vanillins and derivatives,

vanillin,

ethylvanillin,

ortho-vanillin,

isovanillin,

veratric aidehyde,

veratric acid,

vanillic acid,

ortho-vanillic acid,

isovanillic acid,

vanillin and its isomers in sulfite form,

salicylic compounds,

salicylaldehyde,

salicylic acid,

5-nitrosalicylic acid,

5-aminosalicylic acid,

sodium salt of 5-sulfosalicylic acid,

5-chlorosalicylic acid,

5-methylsalicylic acid,

O-acetylsalicylic acid,

salicylamide,

2-hydroxyethoxy-4-hydroxybenzoic acid,

2-hydroxyethoxy- 4-sodiooxysulfonylbenzoic acid.

Among the abovementioned phenolic derivatives, the following derivatives are preferentially chosen:

phenoxyacetic acid,

pyrocatechin,

1,2-bis(2-hydroxyethoxy)benzene,

sodium 4,5-dihydroxybenzene- 1,3-disulfonate,

sodium 4,5-bis(2-hydroxyethoxy)benzene-1,3-disulfonate,

sodium 4,5-bis(2-hydroxy-1-propoxy)benzene-1,3-disulfonate,

3,4-dihydroxybenzaldehyde,

2,3-dihydroxybenzaldehyde,

4-amino-1,2-dihydroxybenzene,

3,4-dihydroxybenzoic acid,

catecholmandelic acid,

salicylaldehyde,

salicylic acid,

5-nitrosalicylic acid,

5-aminosalicylic acid,

sodium salt of 5-sulfosalicylic acid,

5-chlorosalicylic acid,

5-methylsalicylic acid,

O-acetalsalicylic acid,

2-hydroxyethoxy-4-hydroxybenzoic acid,

2-hydroxyethoxy-4-sodiooxysulfonylbenzoic acid.

Among the phenolic derivatives of formula (I), an aromatic compound and preferably a benzenic compound bearing at least one hydroxyl group and at least one ionizable group is preferentially chosen: said ionizable group possibly being borne by the aromatic ring, by a side chain borne by the ring or alternatively forming part of the group attached to the oxygen atom.

The expression “ionizable group” symbolized hereinbelow by G means a group in acid or salified form, such as a carboxylic, carboxylate, sulfonic, sulfonate, hemisulfuric, sulfate, phosphonic, phosphonate, hemiphosphoric or phosphate group in acid or salified form.

The preferred ionizable groups are groups —COOM or —SO₃M in which M represents a hydrogen atom or a metal cation, preferably an alkali metal cation, preferably sodium, or an ammonium group.

A first category of preferred phenolic derivatives featured in the process of the invention is monohydroxylated phenolic derivatives. In this case, the derivative of formula (I) comprises at least one ionizable group G; the group G being on the ring, preferably ortho relative to the hydroxyl group or being borne on the group attached to the oxygen atom.

The derivatives of this category may be represented by formulae (Ia) and (Ib):

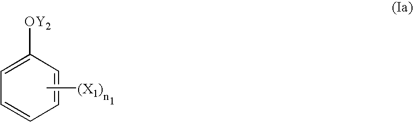

in said formula (Ia), Y₂ represents a group R bearing an ionizable group G, X₁ has the meaning given above and n₁ is a number from 0 to 5.

Examples illustrating formula (Ia) are compounds of phenoxyacetic type.

As regards the other class of monohydroxylated phenolic derivatives, they correspond more particularly to formula (Ib):

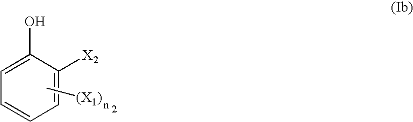

in said formula, X₂ represents an ionizable group, preferably a carboxylic or carboxylate group or a group R bearing an ionizable group G, X₁ has the meaning given above and n₂ is a number form 0 to 4.

The derivatives of the salicylic compound class are illustrated by formula (Ib).

The other category of phenolic derivatives that are advantageous according to the invention is dihydroxylated phenolic derivatives, which may be represented by formula (Ic):

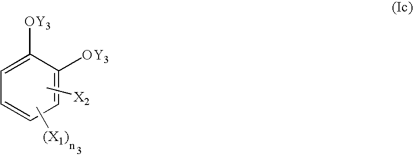

in said formula, X₂ represents an ionizable group, preferably a sulfonic or sulfonate group or a group R bearing an ionizable group G, X₁ has the meaning given above, Y₃ represents a hydrogen atom or a group of formula (F) and n₃ is a number from 0 to 3.

In formula (Ic), n₃ is preferably equal to 1 and X₁ preferably represents an ionizable group, preferably a sulfonic or sulfonate group or a group R bearing an ionizable group G.

The compounds known as TIRON, which are optionally oxyethylenated, illustrate the family of phenolic derivatives corresponding to formula (Ic).

In accordance with the invention, a phenolic derivative is added to a mineral binder. A mixture of phenolic derivatives may also be used.

The process according to the present invention applies to all kinds of mineral binders, especially cements, artificial limes, cement/hydraulic lime or fat lime mixtures, plasters, etc.

The process in accordance with the invention applies particularly successfully to cements. The term “cement” denotes any combination of (lime+silica+alumina) or (lime+magnesia+silica+alumina+iron oxide) commonly known as being hydraulic cements. The preferred cements are cements of Portland type, in which the clinker represents at least 65% of the weight; the optional additions, which are not more than 35% by weight, may be fly ash from power stations, pozzolanas, blast furnace slag, fillers or mixtures of these products. Said Portland cements also generally contain calcium sulfate, which is introduced in the form of gypsum CaSO₄.2H₂O or anhydrite CaSO₄.

Use may also be made of special cements, for instance masonry cements and masonry binders.

As regards aggregates—sand, gravel or stones—, their nature, particle size and proportions may vary within a wide range. All the mixtures of known types may be envisaged.

The mortars and concretes are manufactured according to known and standardized methods.

It should be noted that in practice, the adjuvant of the invention may be introduced at different stages.

Thus, if the phenolic derivative is in solid form, it may be introduced either during the manufacture of the binder, preferably a cement, for example mixed with the clinker, or later in the manufacture of the mineral matrix, by dry-premixing with the other constituents of the mortars and concretes.

In the case of a phenolic derivative in liquid form, it may be deposited on the support (for example silica or calcium carbonate).

If the adjuvant is in liquid or water-soluble form, it may be introduced into the puddling water or introduced during the mixing of the mortar or concrete.

It may also be introduced into the fresh mortar or concrete, immediately before use.

The phenolic derivative is used in an amount that can represent from 0.05% to 3% and preferably from 0.1% to 0.3% of the weight of the binder expressed as dry matter.

In accordance with the present invention, the combination of a phenolic derivative with a mineral binder gives good control of the rheology (control of the consistency of the fresh material), of the setting kinetics and of the acquisition of mechanical performance qualities (compressive and bending tensile strength). The fields of application of the adjuvants of the invention are very wide: concretes in the broad sense, for example building concretes, ready-mix concretes, road concretes, paving concretes and materials for interior work (leveling plaster coats, bonding mortars and repair mortars).

Phenolic Derivative/Silica

Another subject of the invention thus lies in an adjuvant composition for mineral binders, characterized in that it comprises at least one amorphous silica, preferably in aqueous suspension, and at least one phenolic derivative.

It is known practice to use an ultrafine silica to improve the cohesion of grout or fluid mortars or concretes.

However, due to the very high fineness of the silica added, it is necessary either to increase the amount of puddling cement or to use a superplasticizer.

In the first case, on account of the presence of silica, it is necessary, in order to maintain a sufficient level of fluidity, to increase the amount of puddling cement by a few percent. For example, the water/cement weight ratio rises from 0.55 to 0.57. The fact that water is added leads to a reduction in the mechanical strength.

If the second solution is adopted, the addition of a superplasticizer alone can lead to losses of cohesion, a delay in setting and a reduction in the mechanical properties at young ages.

It has now been found, and this constitutes the subject of the present invention, that the combination of silica with a phenolic derivative in a cement matrix has the advantage of no longer making it necessary to increase the amount of puddling cement, which results in a gain in mechanical properties, nor is it obligatory to use a superplasticizer.

One subject of the invention is thus an adjuvant composition for mineral binders, characterized in that it comprises amorphous silica and at least one phenolic derivative.

Thus, it has been demonstrated that the addition of a small amount of phenolic derivative, preferably less than 0.5% relative to the weight of cement, makes it possible to fluidize concrete compositions without entraining air, thus giving concrete compositions that are both dense and fluid, which is not the case with superplasticizers alone, which entrain air.

It has been found that by advantageously combining an adjuvant of phenolic derivative type and an amorphous silica, preferably in the form of an aqueous suspension, the concrete prepared is given improved cohesion, especially by increasing the pumpability and the plasticity when said composition is incorporated into a fluid concrete, or by reducing the rebound when it is introduced into sprayed concrete.

However, it has been found that a silica/phenolic derivative/superplasticizer ternary combination has the advantage of increasing the final mechanical strength.

The presence of the phenolic derivative makes it possible to obtain, unexpectedly, concretes that, when young, have high mechanical characteristics (simple compressive and bending tensile strength), even though there is the presence of a superplasticizer, which is known to retard the acquisition of mechanical performance qualities when young.

The adjuvant compositions according to the invention may be in various physical forms, in the form of powder or of an aqueous suspension.

Another subject of the invention thus lies in an aqueous suspension of amorphous silica, characterized in that it comprises at least one amorphous silica and at least one phenolic derivative.

A first constituent of the adjuvant composition according to the invention is the phenolic derivative as defined above, which preferably corresponds to formula (I) and even more preferentially to formula (Ia), (Ib) or (Ic).

The other constituent of the composition of the invention is an amorphous silica.

In the context of the present invention, the amorphous silica can especially denote fumed silicas, precipitated silicas, silica sols, pyrogenic silicas, silica compounds of natural or synthetic origin, smectites, magnesium silicates in general, and mixtures thereof.

It is preferentially chosen to use a precipitated silica.

The expression “precipitated silica” means herein a silica obtained by precipitation starting with the reaction of an alkali metal silicate with an acid, generally an inorganic acid, at a pH that is suitable for the precipitation medium, in particular a basic, neutral or slightly acidic pH.

Any method may be used to prepare the silica (addition of acid to a silicate stock, total or partial simultaneous addition of acid or of silicate to a stock of water or of silicate solution, etc.), and is chosen depending on the type of silica that it is desired to obtain. After the precipitation step, the step for separating the silica from the reaction medium is generally carried out according to any known means, for example with a filter press or filter under vacuum. A filter cake is thus collected, which is washed if necessary. This cake may, after crumbling, optionally be dried by any known means, especially by atomization, and then optionally ground and/or aggregated. This set of protocols forms the subject of a detailed description in patent application EP 736 501, to which reference will be made.

It is preferably chosen to use the amorphous silica in the form of an aqueous suspension. The reason for this is that it is economically very advantageous to use such suspensions, since by using them it is possible to avoid the use of separate devices for the separate and/or successive introduction of silica and phenolic derivative(s) of the invention.

Moreover, it has been noted that the addition of the phenolic derivative to the aqueous silica suspension increases the stability of the silica suspension, due to its dispersing effect. Furthermore, entirely advantageously the presence of said phenolic derivative gives the suspension better resistance to bacterial attack.

The aqueous suspension featured in the invention advantageously has an amorphous silica content of between 1% and 60% by weight, preferably between 1% and 49% and even more preferentially between 3% and 35% by weight, relative to the total weight of the suspension.

As mentioned above, it is preferred to use a precipitated silica. In the aqueous suspension, the precipitated silica consists of particles generally having a CTAB specific surface area of between 50 and 250 m²/g and in particular between 100 and 240 m²/g. The CTAB surface area is the outer surface area determined according to standard NFT 45007 (November 1987).

The suspension according to the invention advantageously contains a precipitated silica that has good dispersibility and good capacity for disintegration.

It is thus possible to use a precipitated silica as described in EP-A-520 862 and EP-A-736 489.

The silica, in particular the precipitated silica, contained in the aqueous suspension may be finely divided, especially after milling (for example wet milling) or ultrasonic disintegration.

According to another embodiment of the invention, a silica sol is used.

Aqueous silica sols are colloidal aqueous silica dispersions, in which the silica is present in the form of spherical particles that are not crosslinked together and that bear hydroxyl groups at the surface. The physical and chemical properties of silica sols and the process for manufacturing them are described in Ullmanns Enzyklopädie der Technischen Chemie, 4th edition, volume 21, pages 456-458.

When the amorphous silica suspensions are aqueous silica sols, said sols advantageously have a particle size of between 4 and 60 nm and a BET specific surface area ranging from 45 to 700 m²/g.

The BET specific surface area is determined according to the Brauner-Emmet-Teller method described in “The Journal of the American Chemical Society”, vol. 60, page 309, February 1938, and corresponding to standard NFT 45007 (November 1987).

Whether the amorphous silica is in the form of an aqueous or colloidal suspension, in accordance with the process of the invention, it is combined with at least one phenolic derivative.

This derivative may be introduced during or at the end of the preparation of the aqueous silica suspension. It should be noted that this term, used in the text hereinbelow, also covers silica sols.

The amount of the phenolic derivative present in the aqueous silica suspension, expressed as dry extract, can represent from 0.5% to 5% of the total weight of the suspension, and preferably at least 1% of the total weight of the suspension.

A subject of the present invention is also processes for preparing an aqueous suspension including the additive of phenolic type as defined according to the invention.

The aqueous suspension according to the invention may be prepared (in particular at the building site) from a composition in powder form comprising at least one amorphous silica in powder form, and at least one phenolic derivative in powder form according to a process that consists in mixing them together, with stirring (especially mechanical stirring); it suffices to introduce this composition into the puddling water and to blend the mixture obtained.

Said aqueous suspension may also optionally be prepared according to a process that consists in mixing together, with stirring (especially mechanical stirring), at least one amorphous silica corresponding to the above definition, in powder form, with an aqueous solution of the phenolic derivative, and optionally water.

Said aqueous suspension may also optionally be prepared according to a process that consists in mixing together, with stirring (especially mechanical stirring), an aqueous silica suspension of at least one amorphous silica with at least one phenolic derivative in powder form, and optionally water.

Finally, the aqueous suspension may optionally be prepared according to a process that consists in mixing together, with stirring (especially mechanical stirring), an aqueous suspension of at least one amorphous silica, with an aqueous solution of at least one phenolic derivative, and optionally water. In particular, this process consists in adding, with mechanical stirring, an aqueous solution of at least one phenolic derivative to an aqueous suspension of at least one precipitated silica, and optionally water, and in continuing stirring of the mixture thus obtained. The temperature at which the addition is carried out is chosen as a function of the nature of the phenolic derivative, so as to avoid its degradation.

With the aim of preparing a concrete with better fluidity and improved cohesion, the aqueous suspension according to the invention may be added in a proportion of from 0.5% to 15% by weight and preferentially from 2.5% to 5% by weight relative to the weight of cement used to prepare the concrete.

When the composition of the invention is in the form of a powder, it may be prepared by simple dry-mixing of the phenolic derivative in powder form (or optionally deposited on a support if it is liquid such as silica or carbonate) with a silica in powder form.

The respective amounts of the constituents are advantageously:

from 2.5% to 50% by weight of at least one phenolic derivative,

from 50% to 97.5% by weight of silica.

The compositions of the invention apply to all kinds of mineral binders, especially cements, artificial limes, cement/hydraulic lime or fat lime mixtures, plasters, etc.

The process in accordance with the invention applies particularly successfully to cements.

The expression “cement” denotes any combination of (lime+silica+alumina) or (lime+magnesia+silica+alumina+iron oxide) commonly known as being hydraulic cements.

The preferred cements are cements of Portland type, in which the clinker represents at least 65% of the weight; the optional additions, which are not more than 35% by weight, may be fly ash from power stations, pozzolanas, blast furnace slag, fillers or mixtures of these products. Said Portland cements also generally contain calcium sulfate, which is introduced in the form of gypsum CaSO₄.2H₂O or anhydrite CaSO₄.

Use may also be made of special cements, for instance masonry cements and masonry binders.

As regards the aggregates—sand, gravel or stones—, their nature, particle size and proportions may vary within a wide range. Any mixture of known type may be envisaged.

The mortars and concretes are manufactured according to known and standardized methods.

It should be noted that, in practice, since the composition of the invention is in various solid or liquid physical forms, there are many possibilities for introducing it during the manufacture of concretes and mortars.

Thus, if the composition is in solid form, it may be introduced either during the manufacture of the binder, preferably a cement, for example, mixed with the clinker, or later in the manufacture of the mineral matrix, by dry-premixing with the other constituents of the mortars and concretes.

The constituents may be introduced together or separately throughout the manufacture.

If the composition is in liquid form, it may be introduced into the puddling water or introduced during the mixing of the mortar or concrete.

Said composition may also be introduced into the fresh mortar or concrete, immediately before use.

The phenolic derivative is used in any binder composition in an amount that can represent from 0.05% to 3% and preferably from 0.1% to 0.3% of the weight of the binder expressed as dry matter.

The silica is used in an amount that can represent from 0.1% to 5% and preferably from 0.1% to 3% of the weight of the binder expressed as dry matter.

A subject of the invention is also the use of a composition as described above, in a medium of the cement matrix, concrete or mortar type, as an agent for improving the fluidity and cohesion of said medium and the mechanical properties when young, at 28 days and in the long term.

The invention finds an application in paving concretes, leveling plastercoats and more particularly in “specialty” concretes, which need to have particular properties of rheology when fresh, of appearance when hardened, of long-term mechanical strength (especially compressive and bending tensile strength) and, inter alia, of fluidity during use.

Mention may be made, for example, of fluid concretes, pumpable concretes, concretes for manufacturing pavings (cement-based floor screeds or fluid mortars for floor screeds), underwater concretes which must be readily pumpable and injectable, facing concretes, concretes for industrial floors, leveling plastercoats and resurfacing plastercoats, especially for floors, spraying concretes and light concretes, concretes or grouts for injection, for consolidating floors and for cementing oil wells, all these concretes acquiring improved properties by virtue of the invention.

More particularly, in the case of fluid concretes, by virtue of the invention, not only is high fluidity achieved, which is often desirable, but also an improvement in the pumpability, thus making the installation easier.

In the case of spraying concretes, the invention produces, in addition to high cohesion, a considerable reduction in the rebound of the sprayed concrete.

Phenolic Derivative/Silica/Superplasticizer

According to another embodiment of the invention, at least one amorphous silica and one phenolic derivative are combined with a superplasticizer when its presence is required in the intended application.

Specifically, the presence of the phenolic derivative minimizes the side effects resulting from the use of a superplasticizer, namely the entrainment of air which causes the reduction in mechanical strength.

It is thus possible according to the invention to reduce the amount of superplasticizer used, which limits the risks of sweating (rise of laitance to the surface).

Thus, the amount of superplasticizer may be small, i.e. from 0.3% to 2% and preferably 1% relative to the weight of the cement.

In the context of the present invention, the superplasticizer that may be used is any superplasticizer conventionally used in the field under consideration, but care will be taken when choosing it that there is no incompatibility with the phenolic derivative, such as, for example, gelation or setting to a solid or a chemical reaction resulting in the loss of dispersing properties.

More specific examples of superplasticizers that may especially be used include condensates of naphthalenesulfonate or melamine sulfonate type, of alkali metal and alkaline-earth metal polycarboxylate type; alkali metal and alkaline-earth metal polyacrylates; polyalkylene oxides optionally grafted with a calcium-complexing group or derivatives thereof, optionally in combination with an aminoalkylene phosphonate; polymer or copolymer derivatives based on acrylic or methacrylic acid, and terpolymers of acrylic or methacrylic acid or salts thereof.

The alkali metals and alkaline-earth metals may be chosen from sodium, potassium, calcium and magnesium.

Among the abovementioned superplasticizers, polyalkylene oxides grafted with a calcium-complexing group, of the functionalized polyethylene glycol type, such as Chrysofluid Optima 100, are preferred.

Mixtures of superplasticizers may optionally be used.

These superplasticizers are known and described especially in “La pratique des ciments et des bétons [Cements and concretes in practice]” Michel Vénuat (Edition du Moniteur des travaux publics et du bâtiment), pp. 131-137 and “Les bétons, bases et données pour leur formulation [Concretes, bases and data for formulating them]” Jacques Baron and Jean-Pierre Ollivier pp. 96-120/Ecole Francaise du béton.

Compositions comprising the phenolic derivative, silica and the superplasticizer together, in the form of powder or in liquid form, may thus be prepared according to the invention.

One standard preparation method consists in adding the phenolic derivative in solid or liquid form to the superplasticizer, usually in liquid form, and then adding the silica in the form of powder or of suspension.

In the case of a liquid composition, the aqueous suspension of silica, phenolic derivative(s) and superplasticizer(s) has a weight concentration of dry matter usually ranging between 20% and 50%.

Thus, the contents of the various constituents expressed as dry matter may be:

from 5% to 25% by weight of at least one phenolic derivative,

from 20% to 60% by weight of amorphous silica,

form 30% to 75% by weight of at least one superplasticizer.

The preferred compositions comprise:

from 8% to 12% by weight of at least one phenolic derivative,

from 20% to 40% by weight of amorphous silica,

from 50% to 70% by weight of at least one superplasticizer.

More specific examples of compositions of the invention in powder form that may be mentioned include those resulting from the combination of silica and Melment F10® sold by the company C.I.A. Fosroc (condensate of melamine sulfonate type) and of salicylic acid.

As regards the use of this mixture, it may be introduced when it is in the form of powder, with the dry products, such as cements, granulates and other adjuvants and even as a mixture with the clinker.

When it is in the form of an aqueous suspension, it may be added to the puddling water or to the wet pulp obtained during the manufacture of the mortar.

The mixture of silica, phenolic derivative(s) and superplasticizer(s), whether in the form of powder or liquid, is introduced into the cement in a proportion of from 0.5% to 5% by weight.

The mixture may be used to make a grout (composition without filler), a paving concrete, a leveling plastercoat or a self-leveling fluid mortar or concrete.

Its use makes it possible to improve the rheology of the pulp (its fluidity) and to obtain improved mechanical properties for the concrete or mortar obtained.

Phenolic Derivative/Polymer In certain mortars and concretes, it is common practice to add a latex depending on the application.

The term “latex” or “aqueous suspension” denotes a mixture comprising a continuous phase consisting of water and, suspended in this aqueous phase, solid particles or droplets of a water-insoluble polymer.

The term “latex” is abusively used in this field even when the water of the aqueous suspension is removed and the polymer is then in the form of a water-redispersible powder.

Common mortars, mixed with cement and sand, are often used in a thin layer to produce a coat on a wall, a floor screed, a floor, or an attachment layer between a covering, for example tiles, and its support. They may be used as repair mortars or for filling in small holes.

In these applications, various problems arise, such as the problem of adhesion to a support, differential shrinkage of the mortar relative to the support and to the component to be bonded, and volume deformations due to variations in hygrometry.

Thus, to improve the flexibility and adhesion properties, it is known practice to add a latex, a natural or synthetic polymer, in the form of emulsion or powder, to the mortar.

However, it has been found that an increase in temperature (heating) or the presence of moisture (in the support or in the mortar) reduces the level of adhesion, occasionally unacceptably.

It has been found, entirely surprisingly, that the combination of a polymer and a phenolic derivative significantly improves the adhesion under warm conditions and the water resistance.

Another subject of the invention thus lies in an adjuvant composition for mineral binders, characterized in that it comprises at least one polymer and at least one phenolic derivative.

A first embodiment lies in a composition in powder form comprising at least one polymer in powder form and at least one phenolic derivative in solid form.

Another variant lies in an aqueous suspension or latex comprising at least one polymer and at least one phenolic derivative.

A first constituent of the adjuvant composition according to the invention is the phenolic derivative as defined above which preferably corresponds to formula (I) and even more preferentially to formula (Ia), (Ib) or (Ic).

The other constituent forming part of the composition of the invention is a polymer.

The polymer (homopolymer, copolymer, terpolymer or the like) used is of natural or, generally, synthetic origin.

They may be polymers of any type, in the form of water-insoluble particles and especially those derived from the polymerization of ethylenically unsaturated monomers.

The monomers may be chosen from:

styrene, butadiene,

α-methylstyrene or vinyltoluene,

acrylic esters, i.e. esters of acrylic acid and of methacrylic acid with C₁-C₁₂ and preferably C₁-C₈ alkanols, such as methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate,

vinyl nitriles containing from 3 to 12 carbon atoms, in particular acrylonitrile and methacrylonitrile,

vinyl esters of a carboxylic acid, for instance vinyl acetate, vinyl versatate or vinyl propionate,

ethylenically unsaturated monocarboxylic and dicarboxylic acids, for instance acrylic acid, methacrylic acid, itaconic acid, maleic acid or fumaric acid, and monoalkyl esters of dicarboxylic acids of the type mentioned with alkanols preferably containing 1 to 4 carbon atoms and N-substituted derivatives thereof,

unsaturated carboxylic acid amides, for instance acrylamide, methacrylamide, N-methylolacrylamide or N-methylolmethacrylamide,

ethylenic monomers comprising a sulfonic acid group and the alkali metal or ammonium salts thereof, for instance vinylsulfonic acid, vinylbenzenesulfonic acid,

α-acrylamidomethylpropanesulfonic acid or 2-sulfoethylene methacrylate,

ethylenically unsaturated monomers comprising a secondary, tertiary or quaternary amino group or a heterocyclic group containing nitrogen, for example vinylpyridines, vinylimidazole, aminoalkyl (meth)acrylates and aminoalkyl(meth)acrylamides, for instance dimethylaminoethyl acrylate or methacrylate, di-tert-butylaminoethyl acrylate or methacrylate, dimethylaminomethylacrylamide or dimethylaminomethacrylamide, and also zwitterionic monomers, for instance sulfopropyl(dimethyl)aminopropyl acrylate, etc.,

esters of (meth)acrylic acids with alkanediols preferably containing 2-8 carbon atoms, such as glycol mono(meth)acrylate, hydroxypropyl mono(meth)acrylate or 1,4-butanediol mono(meth)acrylate, and also monomers comprising two polymerizable double bonds, for instance ethylene glycol dimethacrylate,

glycidyl (meth)acrylate,

vinyl and acrylic silanes.

According to one preferred mode, the polymer used in the cement according to the invention is derived from the polymerization of at least one ethylenically unsaturated monomer and at least one monomer chosen from monomers containing a carboxylic function and acrylamide or methacrylamide.

In this case, the ethylenically unsaturated monomer may be chosen from: styrene, butadiene, acrylic or methacrylic esters of a C₁-C₁₂ alkyl and the corresponding acids thereof or vinyl esters. It may advantageously be a polymer prepared from a styrene/butadiene mixture as regards the ethylenically unsaturated monomers.

As regards the monomer containing a carboxylic function, it may be chosen from ethylenically unsaturated carboxylic acids. It may be chosen, for example, from acrylic acid, itaconic acid, fumaric acid, crotonic acid, maleic acid, maleic anhydride, mesaconic acid and glutaconic acid, or mixtures thereof.

According to this first mode, the polymers that are most particularly preferred are those prepared from a monomer blend comprising 99.9% to 92% by weight of at least one ethylenically unsaturated monomer and 0.1% to 8% by weight and preferably 2% to 5% of at least one monomer containing a carboxylic function.

According to another preferred mode, the polymer is derived from the polymerization of at least one monomer chosen from vinyl esters of a carboxylic acid, for instance vinyl acetate, vinyl versatate or vinyl propionate. It may especially be a vinyl versatate/vinyl acetate copolymer.

Among the abovementioned monomers, some are preferred for use in the polymer used in the cement.

It may consist of a styrene/butadiene copolymer, a (co)polymer of vinyl ester(s), a (co)polymer of vinyl acetate; a (co)polymer of ethylene acetate.

A vinyl acetate polymer may thus be used.

It is also possible to use a copolymer of vinyl acetate and of at least one vinyl ester of saturated, branched or unbranched monocarboxylic acids containing from 1 to 12 carbon atoms, for instance vinyl propionate, pivalate, laurate or, preferably, versatate (registered trademark denoting mixtures of esters of branched acids containing from 9 to 12 carbon atoms).

The vinyl acetate/vinyl versatate copolymer sold under the name Rhoximat is preferred.

The (co)polymer may also consist of a copolymer of a vinyl ester, in particular of vinyl acetate, and of at least one ester of monocarboxylic or dicarboxylic unsaturated acids containing from 3 to 6 carbon atoms and of an alkyl containing from 1 to 10 carbon atoms, for instance methyl, ethyl, butyl or ethylhexyl acrylate, methacrylate, maleate or fumarate.

The (co)polymer may be used either in the form of powder or as a dispersion in water (in which case it will be referred to as a latex).

A first form of the composition of the invention is an aqueous suspension or latex comprising at least one polymer and at least one phenolic derivative.

The latex is generally obtained after an emulsion polymerization of the monomers.

The polymer content is between 5% and 60% by weight and preferably between 10% and 50% by weight relative to the total weight of the suspension.

The phenolic derivative may be introduced into the polymer suspension. It may be present in the latex suspension in an amount that may advantageously range between 0.1% and 10% by weight of polymer expressed as dry matter, and preferably between 1% and 5%.

Another presentation of the compositions of the invention is a powder form.

The polymer in the form of a powder is dry-mixed with the solid phenolic derivative or, if it is liquid, it may be deposited on a support (silica or carbonate).

The polymer in powder form may be obtained by any method known to those skilled in the art, especially by removing water from a latex.

The water of a latex may be removed, for example, by freezing, followed by sublimation or lyophilization.

It may also be removed by drying, in particular by spray-drying, in the presence of anticaking additives.

Anticaking additives that may be used include a standard mineral filler, for example silica, calcium carbonate, kaolin, barium sulfate, titanium oxide, talc, hydrated alumina, bentonite and calcium sulfoaluminate (satin white).

It is also possible to obtain a powder by introducing the phenolic derivative into the latex and drying them together.

In the powder composition of the invention, the proportions are as follows:

from 0.5% to 50% and preferably from 1% to 10% by weight of a phenolic derivative,

from 50% to 99.5% and preferably from 90% to 99% by weight of a polymer.

The compositions of the invention apply to any kind of mineral binder, especially cements, artificial lines, cement/hydraulic lime or fat lime mixtures, plasters, etc.

The process in accordance with the invention applies particularly successfully to cements.

The term “cement” denotes any combination of (lime+silica+alumina) or (lime+magnesia+silica+alumina+iron oxide) commonly known as being hydraulic cements.

The preferred cements are cements of Portland type, in which the clinker represents at least 65% of the weight; the optional additions, which are not more than 35% by weight, may be fly ash from power stations, pozzolanas, blast furnace slag, fillers or mixtures of these products. Said Portland cements also generally contain calcium sulfate, which is introduced in the form of gypsum CaSO₄.2H₂O or anhydrite CaSO₄.

Use may also be made of special cements, for instance masonry cements and masonry binders.

As regards aggregates—sand, gravel or stones—, their nature, particle size and proportions may vary within a wide range. All the mixtures of known types may be envisaged.

The mortars and concretes are manufactured according to known and standardized methods.

It should be noted that in practice, the composition of the invention is in various solid or liquid physical forms, there are many possibilities for introducing it during the manufacture of concretes and mortars.

Thus, if the composition is in solid form, it may be introduced either during the manufacture of the binder, preferably a cement, for example mixed with the clinker, or later in the manufacture of the mineral matrix, by dry-premixing with the other constituents of the mortars and concretes.

The constituents may be introduced together or separately throughout the manufacture.

If the composition is in liquid form it may be introduced into the puddling water or introduced during the mixing of the mortar or concrete.

Said composition may also be introduced into the fresh mortar or concrete, immediately before use.

The amount by weight of polymer in said mortar is advantageously between 0.1% and 10%, in particular between 0.5-6% more preferentially between 0.1% and 0.3%, relative to the weight of mineral binder. In certain applications, the upper limit may be exceeded or even be up to 20%.

The weight amount of phenolic derivative used in an amount which can represent from 0.05% to 3% and preferably from 0.1% to 0.3% of the weight of the binder expressed as dry matter.

The fields of application of the compositions of the invention are very broad. They may be used in applications involving a latex.

Mention may be made of concretes when these require good resistance to chemical attack, leaktightness, flexibility and resistance to climatic conditions (cold) and to deicing salts.

They are mainly intended for products for interior works, and mention may be made especially of leveling plastercoats, self-leveling mortars, bonding mortars for tiling, interior or exterior plastercoats, mortars for re-covering concrete work, etc.

The compositions according to the invention may be used advantageously in leveling plastercoats. Generally, these leveling plastercoats are binary mixtures of Portland cement and of aluminous cement or ternary mixtures comprising, in addition, calcium sulfate (for example semihydrate, natural gypsum or synthetic gypsums) at up to 10%.

Thus, it has been found that it is possible, by using a phenolic derivative (for example 0.1% to 0.5% by weight of binder), to reduce the amount of aluminous cement relative to the Portland cement, while at the same time maintaining the same open time, the same setting kinetics and at least equivalent mechanical properties. More specifically, the addition of a small amount of phenolic derivative makes it possible to pass, for example, from a cement composition comprising, by weight from:

70% to 75% artificial Portland cement,

25% to 30% aluminous cement,

composition comprising from:

90% to 95% artificial Portland cement,

5% to 10% aluminous cement.

The compositions of the invention may be advantageously used in self-leveling fluid mortars.

The expression “self-leveling fluid mortar” means a mortar generally placed in position by pumping, which gives, after application or pouring onto a horizontal surface, a floor screed that is free of surface irregularities and perfectly horizontal, without any mechanical treatment of the surface (especially such as smoothing out) after pouring said mortar.

Self-leveling fluid mortar comprises at least one mineral binder, preferably a Portland cement (in particular CPA CEM I or CPJ CEM II) or an aluminous cement, calcium sulfate, of natural or synthetic origin, granulates, preferably siliceous or silico-calcareous sand, optionally a setting regulator, a fluidizer, and preferably at least one (co)polymer resin, and water, known as puddling water.

It is thus possible to use an anhydrous calcium sulfate CaSO₄ (in particular anhydrite CaSO₄ of natural origin or synthetic origin, in the form of fluoro-, phosphor sulfo- or titano-anhydrite), and/or a partially hydrated calcium sulfate, in particular α-hemihydrate CaSO₄.½H₂O.

The fluid mortar generally has a granulate/mineral binder weight ratio of between 1 and 6, for example between about 1.2 and 2.0.

The amount of water (known as puddling water) present in the fluid mortar according to the invention is usually between 30% and 60%, for example between 40% and 50%, by weight relative to the weight of mineral binder.

The weight amount of polymer in said mortar is advantageously between 0.5% and 6% and in particular between 1.5% and 3% relative to the weight of mineral binder.

It may also contain a setting accelerator or a liquefier.

Setting accelerators that are advantageously used include potassium sulfate K₂SO₄, lime, especially slaked lime Ca(OH)₂ or, preferably, a mixture of potassium sulfate K₂SO₄ and lime Ca(OH)₂ or a setting retarder, for example lignosulfonates, starches, polysaccharides—such as xanthan gums or guar gums—, acids and salts of hydroxycarboxylic acids of weak acidity such as, for example, citric acid, tartaric acid, oxalic acid, etc.

The total weight amount of setting regulator(s) in said mortar is then generally between 0.1% and 5% and in particular between 0.5% and 2.5% by weight relative to the weight of mineral binder.

Examples of liquefiers that may be mentioned include melamines, polymelamines, polynaphthalenes (especially sodium, calcium or potassium polynaphthalenesulfonate), polyacrylates (especially sodium, calcium or potassium polyacrylate), lignosulfonates, etc.

The fluid mortar according to the invention may also contain at least one liquefier, generally between 0.1% and 2.5% and in particular between 0.2% and 1.5% by weight relative to the weight of mineral binder.

Preferably, the fluid mortar according to the invention comprises, in addition to the phenolic derivative, anhydrite or α-hemihydrate and sand, a vinyl acetate (co)polymer, a liquefier, a setting regulator, lime and water.

In accordance with the invention, the adjuvant according to the invention is used in the fluid mortar according to several embodiments, which may be chosen according to the physical form of the phenolic derivative and of the polymer.

The fluid mortar according to the invention is generally prepared by mixing together the products of which it is formed (puddling operation); said products may be introduced into the mixer in any order.

When the phenolic derivative and the polymer are in powder form, they may be intimately dry-mixed separately, and then introduced into the dry mixture of hydraulic binder, granulates and other additives.

The composition then obtained, and this constitutes another subject of the invention, is one that may be used (in particular on the building site) for the preparation of a self-leveling fluid mortar, this composition having the same formulation (or constitution) as the fluid mortar according to the invention, described above, except that said composition does not comprise water; it then suffices to introduce this composition into the puddling water and to mix the mixture obtained.

It is also possible to prepare the same composition without water, with the exception of the granulates, which are not introduced immediately, but during the puddling. The polymer (and the optional setting regulators and/or liquefiers) may be introduced first into the water preferably, corresponding to the amount of water required for puddling, leading to a latex, and the phenolic derivative is then incorporated therein. The hydraulic binder may then be introduced into the mixture obtained and the whole is then mixed, after which the granulates are gradually added and mixing is continued.

It is also possible to introduce the phenolic derivative prior to the manufacture of the mortar. For example, it may be introduced during the preparation of the latex or during the drying of the latex by any known means (for example an atomization tower), in order to obtain a powder.

A polymer powder containing at least one added phenolic derivative is thus obtained.

The presence of the phenolic derivative in the mortar according to the invention, preferably in a proportion of from 0.1% to 5% of the weight of the binder, improves the rheology of the floor screed obtained using said mortar.

Thus, the invention also relates to the use of a phenolic derivative as an additive for improving the mechanical strength in a floor screed obtained using a self-leveling fluid mortar comprising, besides said additive, at least one mineral binder, granulates and water.

The floor screed obtained using the fluid mortar according to the invention is generally placed in position by pumping and applied, especially by pouring it onto a horizontal surface.

The compositions according to the invention may be advantageously used in bonding mortars. These make it possible to bond together various materials, such as concretes, bricks, tiles, stones, etc. They are essentially used for laying floor tiles and various tiles.

Usually, they are cement mortars comprising from 2% to 20% and preferably from 10% to 20% of a synthetic polymer as mentioned previously, expressed relative to the weight of the cement. They also contain other additives such as fillers and/or pigments; ionic or nonionic emulsifiers, plasticizers (dibutyl phthalate, tricresyl phosphate); thickeners (carboxymethylcellulose, methylcellulose, ethylcellulose, alkali metal and alkaline-earth metal alginates); antigels; antifoams (silicone or dialkylphosphate products containing from 15 to 20 carbon atoms); antifungal agents, etc.

The phenolic derivative may be introduced in powder form into the mixture of solid ingredients (various fillers and cements).

It may also be introduced, whether in solid or liquid form, into the puddling water during the application.

It generally represents from 0.1% to 0.5% of the weight of the binder.

It has been found that the presence of a phenolic derivative leads to an increase in the viscosity, which makes it possible to reduce the amount of thickener, to decrease the slipping of the materials during bonding, and to improve the adhesion characteristics (peel strength of tiles, under various storage conditions). This adhesion is reflected by a failure of “cohesive” type (failure in the bulk of the bonding mortar) during the peel test.

Phenolic Derivative/Superplasticizer

In accordance with the invention, it has been found that using a phenolic derivative avoids the addition of a superplasticizer, since its presence allows good control of rheology (control of the consistency of the fresh material) and of the setting kinetics.

According to another embodiment of the invention, at least one phenolic derivative is combined with a superplasticizer when its presence is required in the intended application.

Specifically, the presence of the phenolic derivative minimizes the side effects resulting from the use of a superplasticizer, i.e. the entrainment of air which causes the reduction in the mechanical strength.

It is thus possible according to the invention to decrease the amount of superplasticizer used, which limits the risks of sweating (rise of laitance to the surface).

Thus, the amount of superplasticizer may be less, i.e. from 0.3% to 1% relative to the weight of the cement.

In the context of the present invention, superplasticizers that may be used include any superplasticizer conventionally used in the field under consideration, but care will be taken when choosing it that there is no incompatibility with the phenolic derivative, such as, for example, gelation or setting to a solid or a chemical reaction resulting in the loss of dispersing properties.

As more specific examples of superplasticizers, reference may be made to the abovementioned list.

Mixtures of superplasticizers may optionally be used.

It is thus possible to prepare according to the invention compositions comprising both the phenolic derivative and the superplasticizer, in the form of powder or in liquid form.

In the case of a liquid composition, the aqueous suspension of phenolic derivative(s) and of superplasticizer(s) has a weight concentration of dry matter usually ranging between 20% and 50%.

Thus, they may comprise:

from 10% to 90% by weight of at least one phenolic derivative,

from 10% to 90% by weight of at least one superplasticizer.

More specific examples of compositions of the invention, in powder form, that may be mentioned include those resulting from the combination of Melment F10® sold by the company C.I.A. Fosroc (condensate of melamine sulfonate type) and of salicylic acid.

As regards the use of this mixture, it may be introduced when it is in powder form, with the dry products, such as cements, granulates and other adjuvants.

When it is in the form of an aqueous suspension, it may be added to the puddling water or to the wet pulp obtained at the time of manufacture of the mortar.

The mixture of phenolic derivative and of superplasticizer(s), whether in the form of powder or liquid, is introduced into the cement in a proportion of from 0.5% to 5% by weight.

The mixture may be used to make a paving concrete, a leveling plastercoat or a self-leveling fluid mortar or concrete.

Its use makes it possible to improve the rheology of the pulp (its fluidity) and to obtain improved mechanical properties for the concrete or mortar obtained.

The present invention specifically describes phenolic derivative/silica or phenolic derivative/polymer or phenolic derivative/superplasticizer combinations, whether they are in solid or liquid form, but it also includes phenolic derivative/silica and/or resin and/or superplasticizer ternary or quaternary combinations.

The examples that follow illustrate the invention without, however, limiting its scope.

### EXAMPLES

The examples relate to three main applications, i.e. paving concretes, bonding mortars for floor tiles, and leveling plastercoats.

### Example 1

Tests on “Paving Concrete” Formulations

The working formulation is as follows:

| | |
|---|---|
| CPA CEM I 52.5 Lafarge “St Vigor” | 350 kg/m³ |
| Fly ash from Carling (Surschites-C.D.F.) | 50 kg/m³ |
| 0/5 R sand | 850 kg/m³ |
| 5/15 R gravel | 1061 kg/m³ |
| Water [E/C = 0.60] | 210 liters |

The test adjuvants are as follows (the amounts are expressed as % of the weight of the cement):

| | |
|---|---|
| a) reference: Glenium 27¹ | 0.5% |
| b) Tiron² | 0.1% |
| c) pyrocatechol | 0.1% |
| d) salicylic acid | 0.1% |
| e) 5-aminosalicylic acid | 0.1% |

¹Glenium is a modified polycarboxylic ether from M.B.T. (S.K.W.).
²Tiron is the disodium salt of 4,5-dihydroxy-1,3-benzenedisulfonic acid.

Pyrocatechol and 5-aminosalicylic acid are referred to hereinbelow, respectively, as “Catechol” and “5-ASA”.

All the ingredients were added in powder form (except for the Glenium 27, which is in liquid form), to the fresh concrete (after introducing the puddling water).

1. Effects on the Rheology of the Concretes:

The rheology of the test concretes was characterized by means of the Flow Test (tests with shaking table, according to ASTM standard C124 and A.A.S.H.T.O. standard T120) and the Slump Test (tests with an Abrams cone, according to NF standard P.18-451 and ISO standard 4109).

The results obtained are given in table (I).

TABLE (I)
Rheological characterization of paving concrete formulations containing
phenolic derivatives

| | | | | | +0.1% | |
|---|---|---|---|---|---|---|
| | Control | +0.5% | +0.1% | +0.1% | Salicylic | +0.1% |
| | concrete | Glenium ® 27 | Tiron ® | Catechol | acid | 5-ASA |
| Fresh density ρₒ | 2.31 | 2.19 | 2.41 | 2.33 | 2.26 | 2.30 |
| Slump test (cm) | 4.5 | 10 | 4 | 2 | 4.5 | 5 |
| Spreading with 0 taps (mm) | 260 | 290 | 260 | 260 | 260 | 260 |
| Spreading with 5 taps (mm) | 280 | 420 | 322 | 280 | 310 | 310 |
| Spreading with 10 taps (mm) | 310 | 500 | 370 | 300 | 360 | 355 |
| Spreading with 15 taps (mm) | 350 | 540 | 420 | 330 | 410 | 410 |

It is observed that the products of salicylic acid, 5-ASA and Tiron type lead to an improvement in the fluidity of the fresh paste.

Catechol leads to a phenomenon of compaction of the paste, which may be associated with an acceleration of the setting phenomenon.

Glenium 27 leads to better rheological characteristics, but this appears to be partly associated with a phenomenon of air entrainment (cf. density values of the fresh pastes).

2. Effect on the Mechanical Strength:

The strength tests were carried out on prism-shaped test pieces 7×7×28 cm³ in size (NF standard P. 18-400, ASTM standard C31 and A.A.S.H.T.O. standard T23) removed from the molds after 24 hours and stored at 20° C., in water saturated with lime.

The mechanical tests took place after 2, 7 and 28 days.

The results obtained are given in table (II).

TABLE (II)
Mechanical characterization of paving concrete formulations
containing phenolic derivatives

| | Control | +0.5% | +0.1% | +0.1% | +0.1% | +0.1% |
|---|---|---|---|---|---|---|
| | concrete | Glenium 27 | Tiron ® | Catechol | salicylic acid | 5-ASA |
| σ_{t/b} at 2 days | 3.7 | 4.3 | 4.2 | 3.8 | 3.5 | 3.5 |
| σ_{sc} at 2 days | 19.5 | 20.6 | 20.7 | 19.5 | 17.4 | 16.5 |
| σ_{t/b} at 7 days | 6.9 | 7.3 | 7.1 | 7.0 | 6.8 | 6.5 |
| σ_{sc} at 7 days | 40.4 | 38.1 | 47.4 | 42.1 | 39.7 | 41.7 |
| σ_{t/b} at 28 days | 6.8 | 7.5 | 7.7 | 7.2 | 7.4 | 7.9 |
| σ_{sc} at 28 days | 44.5 | 49.1 | 55.0 | 51.6 | 53.7 | 55.1 |

σ_{t/b}: tensile breaking stress by bending [MPa]
σ_{sc}: breaking stress in simple compression [MPa]

5-ASA leads to the best performance, at the 28 day-stage, as regards the tensile strength by bending σ_{t/b}. All the adjuvant-containing concretes lead to higher performance qualities than those of the control concrete (adjuvant-free concrete).

As regards the strength in simple compression σ_{sc}, it is observed that Tiron achieves the best performance, irrespective of the stage of measurement.

5-ASA gives equivalent results, at the 28-day stage.

3. Effect on the Density of the Hardened Matrices

The density measurements were carried out on fresh paste (density ρ₀) by weighing calibrated containers (prism-shaped test pieces 7×7×28 cm³ in size).

The density of the hardened test pieces (ρₛ) was measured after 1, 2, 7 and 28 days, after removing the test pieces from their storage water, drying the surface with absorbent paper and then conditioning for 3 hours in the open air.

The values obtained are given in table (III)

TABLE (III)
Density measurements (ρₒ; ρₛ) carried out on paving
concrete formulations containing phenolic derivatives

| | Control | +0.5% | +0.1% | +0.1% | +0.1% | +0.1% |
|---|---|---|---|---|---|---|
| | concrete | Glenium ® 27 | Tiron ® | Catechol | salicylic acid | 5-ASA |
| Fresh density ρₒ | 2.31 | 2.19 | 2.41 | 2.33 | 2.26 | 2.30 |
| Density ρₛ at 1 day | 2.37 | 2.31 | 2.36 | 2.38 | 2.37 | 2.32 |
| Density ρₛ at 2 days | 2.33 | 2.30 | 2.32 | 2.38 | 2.33 | 2.28 |
| Density ρₛ at 7 days | 2.40 | 2.33 | 2.41 | 2.39 | 2.39 | 2.36 |
| Density ρₛ at 28 days | 2.39 | 2.34 | 2.37 | 2.39 | 2.40 | 2.33 |

It is observed that Tiron gives the highest density values, during the first measurement stages.

At the end of the first 28 days of hydration, the density of the concrete with added Tiron is slightly lower than that of the control concrete, although the mechanical performance qualities are markedly in favor of the first.

This appears to be a sign of the formation of stronger phases or of a particular change in the microstructure (crystal stacking, etc.) of the material, which tends to improve its mechanical performance.

### Example 2

Tests on “Leveling Plastercoat” Formulations

The working formulation is as follows:

| CPA CEM I 52.5 Lafarge | 24.7 | g (73% of the |
|---|---|---|
| “St Vigor” | weight of binder | |
| Aluminous cement T.R.G. | 9.0 | g (27% of the |
| Lafarge | weight of binder) | |
| Casein | 0 or 0.5 | g |
| Durcal 65¹ (Omya) | 19.875 | g |
| Slaked lime Ca (OH)₂ | 2.95 | g |
| Sand NE 03 (Sifraco) | 40.6 | g |
| Tylose 200 XP² (Hoechst) | 0.1 | g |
| Bevaloid 770 DD³ | 0.15 | g |
| Trisodium citrate | 0.125 | g |
| Rhoximat PAV 30⁴ | 2 | g |
| Puddling water | 24 | parts |

¹Durcal 65 is calcium carbonate
²Tylose 200 XP is a cellulose ether
³Bevaloid 770 DD is a polyglycol adsorbed onto silica
⁴Rhoximat PAV 30 and a vinyl acetate/vinyl versatate copolymer.

The phenolic derivatives were used in proportions of 0.1% or 0.2% of the weight of binder (CPA+CA).

The results obtained are given in tables (IV) and (V):

TABLE (IV)
Characteristics of leveling plastercoats without
phenolic derivatives

| | Binder: | Spreading (mm)* | | | | VICAT setting* | |
|---|---|---|---|---|---|---|---|
| | 73% CPA - | | | | 35 | start of | end of |
| No. | 27% TRG | 5 min | 15 min | 25 min | min | setting | setting |
| 1 | Control | 80 | 70 | / | / | 58 min | 1 h 10 |
| | (casein-free) | | | | | | |
| 2 | Control | 135 | 116 | 96 | / | 58 min | 1 h 16 |

| | |
|---|---|
| (with 0.5% | Sclerometer test: good |
| casein) | |

*The spreading test is carried out according to the description of the CSTB technical guide “Produits et systèmes de réparation de sols intérieurs pour la pose de revêtements minces [Products and systems for repairing interior floors for laying thin coverings]” - Cahiers du CSTB No. 2893 (June 96).
*The VICAT setting is carried out according to standard NF-P-15-431.

TABLE (V)
Characteristics of leveling plastercoats with added
phenolic derivatives

| | Binder: | Spreading (mm) | | | | VICAT setting | |
|---|---|---|---|---|---|---|---|
| | 90% CPA - | | | | 35 | start of | end of |
| No. | 10% TRG | 5 min | 15 min | 25 min | min | setting | setting |
| 3 | Control | 135 | 135 | 132 | 120 | 52 min | 1 h 08 |
| | (with 0.5% | Sclerometer test: poor | | | | | |
| | casein) | | | | | | |
| 4 | +0.2% | 128 | 112 | / | 70 | 1 h | 1 h 15 |

| | |
|---|---|
| Catechol | Sclerometer test: good (idem. formulation 2) |

It is observed that, when Catechol is used, it is possible to reduce the dosage of aluminous cement. It becomes possible according to the invention to go from a dosage of 27%, in the reference formulations, to a dosage of 10% in the formulations of the invention.

The advantage lies in improving the mechanical performance, associated with the reduction in the dosage of aluminous cement (used in combination with Portland cement).

### Example 3

Tests on Formulations of “Bonding Mortar for Floor Tiles”

The working formulation is as follows:

| | | |
|---|---|---|
| CPA CEM I 52.5 Lafarge “St Vigor” | 36.2 | g |
| Sand EN 31 (Sifraco) | 58.3 | g |
| Culminal 8121¹ (Aqualon) | 0.2 | g |
| Culminal 8564² (Aqualon) | 0.3 | g |
| Rhoximat PAV 30 | 5 | g |
| Amount of puddling [E/S] | 24 | parts |

¹Culminal 8121 is a cellulose ether, methylhydroxypropylcellulose, of viscosity 20 000 cps, measured on an aqueous 2% solution,
²Culminal 8121 is also a cellulose ether, methylhydroxyethylcellulose, of viscosity 14 000 cps, measured on an aqueous 2% solution.

The phenolic adjuvants used (in a proportion of 0.2% of the weight of binder) are as follows:

Tiron

Salicylic acid

Catechol

5-ASA

The results obtained are given in table (VI)

TABLE VI
Characteristics of bonding mortars for floor tiles,
with added phenolic derivatives

| | Formulation | Fresh | | |
|---|---|---|---|---|
| | CPA CEM I 52.5 | density | Viscosity* | Slippage* |
| No. | “St Vigor” | ρo | (cPs) | (mm) |
| 1 | Control | 1.50 | 128 000 | 7.0 |
| 2 | +0.2% Tiron | 1.50 | 148 000 | 3.5 |
| 3 | +0.2% Salicylic acid | 1.50 | 144 000 | 3.5 |
| 4 | +0.2% Catechol | 1.59 | 168 000 | 2.0 |
| 5 | +0.2% 5-ASA | 1.50 | 140 000 | 5.0 |

*Measurements taken using a Brookfield “Helipath” viscometer, at 20 rpm.
*The slippage test is carried out according to standard NF-EN-1308.

Catechol substantially reduces the slippage of the tiles (increase in viscosity). This effect is even more pronounced when the bonding mortar contains no latex powder [cf. table (VII)]: the viscosity of the paste rises from 120 000 cPs to a value of 188 000 cPs (+57%).

TABLE VII
Confirmation of the effect of Catechol on the density
of a bonding mortar formulation without latex powder

| | Fresh density ρo | Viscosity* (cPs) |
|---|---|---|
| Control | 1.68 | 120 000 |
| +0.2% Catechol | 1.76 | 188 000 |

*Measurements taken using a Brookfield “Helipath” viscometer, at 20 rpm.

It may thus be deduced therefrom that it is possible to reduce the amount of viscosifier used in the base formulation, without this harming the working properties of the mortar.

As regards the adhesion characteristics of the tiles (peel strength), table (VIII) summarizes the results obtained.

TABLE (VIII)
Characteristics of bonding mortars with added phenolic
derivatives
1. Measurements of adhesion after 7 days under dry conditions
2. Measurements after 7 days under dry conditions
and 7 days in water

| | | | |
|---|---|---|---|
| | | | Adhesion in |
| | | | MPa (7 days |
| Fresh | | Adhesion in MPa | dry - 7 days |
| density | Viscosity* | (7 days dry) | wet) |

| | ρₒ | (cPs) | 5 min | 10 min | 5 min | 10 min |
|---|---|---|---|---|---|---|
| Control | 1.53 | 150 000 | 1.64/A | 1.23/A | 0.45/A | 0.33/A |
| +0.2% | 1.47 | 128 000 | 1.72/C++ | 1.70/C+ | 1.0/C++ | 0.78/A |
| salicylic | | | | | | |
| acid | | | | | | |

*Measurements taken using a Brookfield “Helipath” viscometer, at 20 rpm.
A: “Adhesive” failure
C: “Cohesive” failure
*The adhesion test is carried out according to standard NF-EN-1348.

The addition of a compound such as salicylic acid improves the peel strength values; the failure takes place in a “cohesive” mode, which is in a positive sense.

### Example 4

“Phenolic Derivatives/Precipitated Silica” Combinations

In the tests, amorphous precipitated silica SiO₂, in the form of a slurry containing 22% dry extract (Rhoximat CS 60 SL) is combined with phenolic derivatives, in proportions of “30 parts/1 part”.

Once the mixtures have been prepared, their working properties are evaluated in standardized mortar formulations (mortars ISO ⅓), the details of which are as follows:

| | |
|---|---|
| CPA CEM I 52.5 Lafarge “St Vigor” | 450 g |
| Standardized sand (compliance with ISO 679) | 1350 g |
| Water [E/C = 0.50 ] | 225 g |

“Mixed” suspensions of precipitated silica slurry (with added phenolic derivatives) in proportions of 3%, relative to the weight of cement, are used.

Once the mortars have been manufactured (puddling in a Perrier type 32 standardized mixer), their rheological characteristics are studied as regards the spreading on a shaking table (according to standards EN 459-2 and ISO 2768-1).

The results obtained are given in table (IX).

TABLE (IX)
Rheological characteristics of standardized mortars with added
“precipitated silica SiO₂/phenolic derivatives” mixed
suspensions

| | | | +3% | | +3% |
|---|---|---|---|---|---|
| | | | mixed | +3% | mixed |
| Relative | | +3% | slurry | mixed | slurry |
| spreading* | Control | “CS 60 | “SiO₂/ | slurry | “SiO₂/salicylic |
| (%) | mortar | SL” | Tiron” | “SiO₂/5-ASA” | acid” |
| Spreading | 0% | 0% | 0% | 0% | 0% |
| after 0 | | | | | |
| blows | | | | | |
| Spreading | 25% | 20% | 30% | 25% | 30% |
| after 5 | | | | | |
| blows | | | | | |
| Spreading | 45% | 35% | 50% | 50% | 55% |
| after 10 | | | | | |
| blows | | | | | |
| Spreading | 55% | 50% | 65% | 70% | 75% |
| after 15 | | | | | |
| blows | | | | | |

*(D_{x blows} − D₀/D₀) × 100

During the addition of the “Rhoximat CS 60 SL” silica slurry alone, at a dosage of 3% of the weight of cement (given that the amount of puddling “E/C” was kept constant), a decrease in the plasticity of the paste is observed.

On the other hand, when the silica slurry is combined with products of Tiron, 5-ASA or salicylic acid type, the spreading values are improved, both relative to the control mortar (adjuvant-free) and relative to the mortar containing the “Rhoximat CS 60 SL” slurry alone.

### Example 5

“Phenolic Compounds/Superplasticizers” Combinations

Examples that may be mentioned include the following superplasticizers:

Glenium® 51 (M.B.T.-S.K.W.)

Chrysofluid® Optima 100 (Chryso-Lafarge)

The proportions adopted are as follows:

10 parts of “superplasticizer”/1 part “phenolic compound”.

The objective is to improve the rheological properties, while benefiting from the gain in strength generated by the phenolic compound (table II).

The rheological assessment was carried out on an ISO ⅓mortar, the amount of puddling of which was set at an E/C value=0.35.

The spreading values obtained are as follows:

TABLE X
“Phenolic compounds/superplasticizers” combinations
Tests of spreading on a shaking table

| | Control + | Control + |
|---|---|---|
| Number of blows | 1% Glenium ® 51 | 1% (Glenium ® 51/ASA |
| 0 | 100 | 100 |
| 5 | 105 | 108 |
| 10 | 115 | 120 |
| 15 | 128 | 130 |

1. An adjuvant composition for mineral binders, characterized in that it comprises at least one phenolic derivative.

2. The composition as claimed in claim 1, characterized in that the phenolic derivative is any aromatic and preferably benzenic compound bearing at least one hydroxyl group in free or functionalized form and bearing at least one other group comprising an oxygen and/or nitrogen and/or sulfur and/or phosphorus atom: said group possibly being borne by the aromatic ring, by a side chain borne by the ring or alternatively forming part of the group attached to the oxygen atom.

3. The composition as claimed in either of claims 1 and 2, characterized in that the phenolic derivative used corresponds to formula (I): 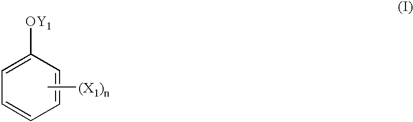
in said formula (I):
Y₁ represents:
a hydrogen atom,
a linear or branched alkyl group containing from 1 to 12 carbon atoms and preferably from 1 to 4 carbon atoms,
an acyl group of formula R₃—CO— in which R₃ represents a linear or branched alkyl group containing from 1 to 17 carbon atoms,
a group R which may be a linear or branched alkyl group containing from 1 to 12 carbon atoms or an alkenyl or alkynyl group containing from 2 to 12 carbon atoms bearing an ionizable group G in acid or salified form, such as a carboxylic, carboxylate, sulfonic, sulfonate, hemisulfuric, sulfate, phosphonic, phosphonate, hemiphosphoric or phosphate group in acid or salified form,
a group of formula (F): 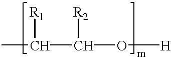
(F) in which the groups R₁ and R₂, which may be identical or different, represent a hydrogen atom or a methyl or ethyl group: when one of the groups R₁ or R₂ is a methyl or ethyl group, the other group R₁ or R₂ is then a hydrogen atom and m is a number between 1 and 50;
X₁ represents:
a hydroxyl group,
an ionizable group G in acid or salified form, such as a carboxylic, carboxylate, sulfonic, sulfonate, hemisulfuric, sulfate, phosphonic, phosphonate, hemiphosphoric or phosphate group in acid or salified form,
a group R which may be a linear or branched alkyl group containing from 1 to 12 carbon atoms or an alkenyl or alkynyl group containing from 2 to 12 carbon atoms bearing an ionizable group G in acid or salified form, such as a carboxylic, carboxylate, sulfonic, sulfonate, hemisulfuric, sulfate, phosphonic, phosphonate, hemiphosphoric or phosphate group in acid or salified form,
a group —O—Y₂, Y₂, which may be identical to or different than Y₁, having the same meaning,
a linear or branched alkyl group containing from 1 to 18 carbon atoms, preferably methyl, ethyl, propyl, isopropyl, butyl, isobutyl, sec-butyl, tert-butyl, dodecyl, hexadecyl or octadecyl;
a linear or branched alkenyl group containing from 2 to 6 carbon atoms and preferably from 2 to 4 carbon atoms, such as vinyl or allyl,
a linear or branched alkoxy group containing from 1 to 6 carbon atoms and preferably from 1 to 4 carbon atoms, such as methoxy, ethoxy, propoxy, isopropoxy or butoxy groups, an alkenyloxy group, preferably an allyloxy group or a phenoxy group,
an acyl group of formula R₃—CO—in which R₃ represents a linear or branched alkyl group containing from 1 to 17 carbon atoms, preferably acetyl, lauroyl, palmitoyl or stearoyl,
an ═O group,
a —CHOH—COOH group,
a group of formula:
—R₄—OH
—R₄—CHO
—R₄—NO₂
—R₄—NH₂
—R₄—CO—NH₂
—R₄—NH—CH₂—CH₂—OH
—R₄—N—[CH₂—CH₂—OH]₂
—R₄—NH—CH₂—CO₂H
—R₄—N—[CH₂—CO₂H]₂
in said formulae, R₄ represents a valency bond or a linear or branched, saturated or unsaturated divalent hydrocarbon group containing from 1 to 6 carbon atoms such as, for example, methylene, ethylene, propylene, isopropylene or isopropylidene;
the groups R₅, which may be identical or different, represent a hydrogen atom, a linear or branched alkyl group containing from 1 to 6 carbon atoms, or a metal cation, preferably an alkali metal cation or an ammonium group,
if n is equal to 0, Y₁ represents a group R,
if Y₁ represents a hydrogen atom, n is at least equal to 1,
n is a number ranging from 0 to 5 and preferably equal to 1, 2 or 3.

4. The composition as claimed in claim 3, characterized in that the phenolic derivative corresponds to formula (I) in which the group Y₁ represents a hydrogen atom and X₁ represents a formyl group or a carboxylic group.

5. The composition as claimed in claim 3, characterized in that the phenolic derivative corresponds to formula (I) in which the group Y₁ represents an oxyalkylenated group of formula (F) in which the group R₂ represents a hydrogen atom or a methyl group and the group R₁ represents a hydrogen atom.

6. The composition as claimed in claim 3, characterized in that the phenolic derivative corresponds to formula (I) in which the group Y₁ represents an oxyalkylenated group of formula (F₁): 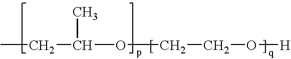
(F₁) in which p and q are numbers such that:
p+q=m,
p+q≠1
p is between 0 and 5,
q is between 0 and 10.

7. The composition as claimed in either of claims 5 and 6, characterized in that the phenolic derivative is an oxyalkylenated phenolic derivative corresponding to formula (I) in which X₁ represents one or two sulfonic groups in salified form, preferably in the form of an alkali metal (preferentially sodium or potassium), an alkaline-earth metal or an ammonium group.

8. The composition as claimed in claim 1, characterized in that the phenolic derivative is chosen from: diphenolic compounds, vanillin precursors and derivatives, salicylic compounds and nitrogenous phenolic compounds.

9. The composition as claimed in claim 3, characterized in that the phenolic derivative is chosen from:
phenoxyacetic acid,
pyrocatechin,
1,2-bis(2-hydroxyethoxy)benzene,
sodium 4,5-dihydroxybenzene-1,3-disulfonate,
sodium 4,5-bis(2-hydroxyethoxy)benzene-1,3-disulfonate,
sodium 4,5-bis(2-hydroxy-l-propoxy)benzene-1,3-disulfonate,
3,4-dihydroxybenzaldehyde,
2,3-dihydroxybenzaldehyde,
4-amino-1,2-dihydroxybenzene,
3,4-dihydroxybenzoic acid,
catecholmandelic acid,
salicylaldehyde,
salicylic acid,
5-nitrosalicylic acid,
5-aminosalicylic acid,
sodium salt of 5-sulfosalicylic acid,
5-chlorosalicylic acid,
5-methylsalicylic acid,
O-acetylsalicylic acid,
2-hydroxyethoxy-4-hydroxybenzoic acid,
2-hydroxyethoxy-4-sodiooxysulfonylbenzoic acid.

10. The composition as claimed in one of claims 1 to 9, characterized in that the phenolic derivative corresponds to formula (Ia): 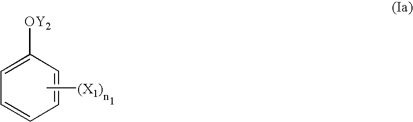
in said formula (Ia), Y₂ represents a group R bearing an ionizable group G, X₁ has the meaning given above and n₁ is a number from 0 to 5.

11. The composition as claimed in one of claims 1 to 9, characterized in that the phenolic derivative corresponds to formula (Ib): 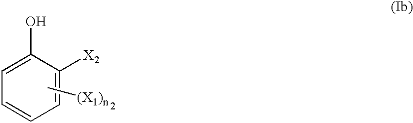
in said formula, X₂ represents an ionizable group, preferably a carboxylic or carboxylate group or a group R bearing an ionizable group G, X₁ has the meaning given above and n₂ is a number from 0 to 4.

12. The composition as claimed in one of claims 1 to 9, characterized in that the phenolic derivative corresponds to formula (Ic): 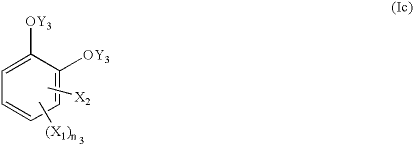
in said formula, X₂ represents an ionizable group, preferably a sulfonic or sulfonate group or a group R bearing an ionizable group G, X₁ has the meaning given above, Y₃ represents a hydrogen atom or a group of formula (F) and n₃ is a number from 0 to 3.

13. The composition as claimed in claim 12, characterized in that the phenolic derivative corresponds to formula (Ic) in which n₃ is preferably equal to 1 and X₁ preferably represents an ionizable group, preferably a sulfonic or sulfonate group or a group R bearing an ionizable group G.

14. The composition as claimed in one of claims 1 to 12, characterized in that the phenolic derivative is used in an amount representing from 0.05% to 3% and preferably from 0.1% to 0.3% of the weight of the binder expressed as dry matter.

15. An adjuvant composition for mineral binders, characterized in that it comprises amorphous silica and at least one phenolic derivative described in one of claims 1 to 13.

16. A composition in powder form, characterized in that it comprises at least one phenolic derivative described in one of claims 1 to 13 and an amorphous silica, preferably a precipitated silica.

17. The composition as claimed in claim 16, characterized in that it comprises:
from 2.5% to 50% by weight of at least one phenolic derivative,
from 50% to 97.5% by weight of silica.

18. A process for preparing the composition described in claim 16, characterized in that the phenolic derivative in powder form and a silica in powder form are dry-mixed.

19. A process for preparing concrete, characterized in that the composition as claimed in either of claims 16 and 17 is added to the concrete.

20. The process as claimed in claim 19, characterized in that the composition is added either during the manufacture of the binder, preferably mixed with the clinker, or later in the manufacture of the mineral matrix, by dry-premixing with the other constituents of the mortars and concretes: the constituents possibly being introduced together or separately throughout the manufacture.

21. An aqueous suspension of amorphous silica, characterized in that it comprises at least one phenolic derivative described in one of claims 1 to 13.

22. The aqueous suspension as claimed in claim 21, characterized in that the amorphous silica is a precipitated silica.

23. The aqueous suspension as claimed in either of claims 21 and 22, characterized in that the amorphous silica content is between 1% and 60% by weight, preferably between 1% and 49% by weight and even more preferentially between 3% and 35% by weight relative to the total weight of the suspension.

24. The aqueous suspension as claimed in one of claims 21 to 23, characterized in that the phenolic derivative is present in an amount representing from 0.5% to 5% by weight and preferably at least 1% by weight relative to the total weight of the suspension.

25. A process for preparing the aqueous silica suspension described in one of claims 21 to 24, characterized in that it consists:
either in mixing together, with stirring, at least one amorphous silica, in powder form, with at least one phenolic derivative, in powder form, and water,
or in mixing together, with stirring, at least one amorphous silica, in powder form, with an aqueous solution of at least one phenolic derivative, and optionally water,
or in mixing together, with stirring, an aqueous suspension of at least one amorphous silica, with at least one phenolic derivative in powder form, and optionally water,
or in mixing together, with stirring, an aqueous suspension of at least one amorphous silica, with an aqueous solution of at least one phenolic derivative, and optionally water.

26. A process for preparing a mortar or concrete, characterized in that the aqueous suspension as claimed in one of claims 21 to 24 is added to the mortar or concrete.

27. The process as claimed in claim 26, characterized in that the aqueous suspension is added to the mortar or concrete in a proportion of from 0.1% to 15% by weight and more preferentially from 2.5% to 5% relative to the weight of cement used to prepare the concrete.

28. The process as claimed in claim 21, characterized in that the aqueous suspension is added at the time of mixing the concrete, or into the puddling water.

29. The composition as claimed in one of claims 1 to 13, 15 to 17 and 21 to 24, characterized in that it also comprises a superplasticizer.

30. The composition as claimed in claim 29, characterized in that the superplasticizer is chosen from condensates of naphthalenesulfonate or melamine sulfonate type, of alkali metal and alkaline-earth metal polycarboxylate type; alkali metal and alkaline-earth metal polyacrylates; polyalkylene oxides optionally grafted with a calcium-complexing group or derivatives thereof, optionally in combination with an aminoalkylene phosphonate; polymer or copolymer derivatives based on acrylic or methacrylic acid, and terpolymers of acrylic or methacrylic acid or salts thereof.

31. The composition as claimed in claim 29, characterized in that it comprises:
from 5% to 25% and preferably from 8% to 12% by weight of at least one phenolic derivative,
from 20% to 60% and preferably from 20% to 40% by weight of amorphous silica,
from 30% to 75% and preferably from 50% to 70% by weight of at least one superplasticizer.

32. The composition as claimed in one of claims 29 to 31, characterized in that it is in powder form.

33. The composition as claimed in one of claims 29 to 31, characterized in that it is in the form of an aqueous suspension.

34. The composition as claimed in claim 33, characterized in that the dry matter content of the suspension is from 20% to 50% by weight.

35. The composition as claimed in one of claims 29 to 34, characterized in that it is used in an amount representing from 0.5% to 5% of the weight of the cement.

36. An adjuvant composition for mineral binders, characterized in that it comprises at least one polymer and at least one phenolic derivative described in one of claims 1 to 13.

37. The composition as claimed in claim 36, characterized in that the polymer is a styrene/butadiene copolymer, a (co)polymer of vinyl ester(s), a (co)polymer of vinyl acetate; a (co)polymer of ethylene acetate, a copolymer of vinyl acetate and of at least one vinyl ester of saturated, branched or unbranched monocarboxylic acids containing from 1 to 12 carbon atoms, a copolymer of a vinyl ester and of at least one ester of mono-or dicarboxylic unsaturated acids containing from 3 to 6 carbon atoms and of an alkyl containing from 1 to 10 carbon atoms.

38. The composition as claimed in claim 37, characterized in that the polymer is a vinyl acetate/vinyl versatate copolymer.

39. A composition in powder form, characterized in that it comprises at least one polymer described in either of claims 37 and 38 and at least one phenolic derivative described in one of claims 1 to 13.

40. The composition as claimed in one of claims 36 to 40, characterized in that it comprises:
from 0.5% to 50% and preferably from 1% to 10% by weight of a phenolic derivative,
from 50% to 99.5% and preferably from 90% to 99% by weight of a polymer.

41. A process for preparing the composition described in one of claims 36 to 40, characterized in that it consists in dry-mixing at least one phenolic derivative in powder form and at least one polymer in powder form.

42. A process for preparing a mortar or concrete, characterized in that the composition as claimed in one of claims 36 to 40 is added to the mortar or concrete, the constituents possibly being introduced together or separately throughout the manufacture.

43. The process as claimed in claim 42, characterized in that the composition is added either during the manufacture of the binder, preferably mixed with the clinker or earlier in the manufacture of the mineral matrix, by dry-premixing with the other constituents of the mortars and concretes.

44. A latex of at least one polymer, characterized in that it comprises at least one phenolic derivative described in one of claims 1 to 13.

45. The latex as claimed in claim 44, characterized in that the polymer is a styrene/butadiene copolymer, a (co)polymer of vinyl ester(s), a (co)polymer of vinyl acetate; a (co)polymer of ethylene acetate, a copolymer of vinyl acetate and of at least one vinyl ester of saturated, branched or unbranched monocarboxylic acids containing from 1 to 12 carbon atoms, a copolymer of a vinyl ester and of at least one ester of mono-or dicarboxylic unsaturated acids containing from 3 to 6 carbon atoms and of an alkyl containing from 1 to 10 carbon atoms.

46. The latex as claimed in either of claims 44 and 45, characterized in that the polymer is present in an amount of between 5% and 60% by weight and preferably between 10% and 50% by weight relative to the total weight of the suspension.

47. The latex as claimed in one of claims 44 to 46, characterized in that the phenolic derivative is present in an amount ranging from 0.1% to 10% of the weight of resin expressed as dry matter, and preferably between 1% and 5%.

48. A process for preparing a mortar or concrete, characterized in that the latex described in one of claims 44 to 47 is introduced into the mineral binder, the mixture is then mixed and the granulates are added, and mixing is continued.

49. An adjuvant composition for mineral binders, characterized in that it comprises at least one phenolic derivative described in one of claims 1 to 13 and at least one superplasticizer.

50. The composition as claimed in claim 49, characterized in that the superplasticizer is chosen from condensates of naphthalenesulfonate or melamine sulfonate type, of alkali metal and alkaline-earth metal polycarboxylate type; alkali metal and alkaline-earth metal polyacrylates; polyalkylene oxides optionally grafted with a calcium-complexing group or derivatives thereof, optionally in combination with an aminoalkylene phosphonate; polymer or copolymer derivatives based on acrylic or methacrylic acid, and terpolymers of acrylic or methacrylic acid or salts thereof.

51. The composition as claimed in claim 50, characterized in that the superplasticizer is a modified polycarboxylic ether of M.B.T. or a polyalkylene oxide grafted with a calcium-complexing group, of the functionalized polyethylene glycol type.

52. The composition as claimed in either of claims 50 and 51, characterized in that it comprises:
from 10% to 90% by weight of at least one phenolic derivative,
from 10% to 90% by weight of at least one superplasticizer.

53. The composition as claimed in one of claims 49 to 52, characterized in that it is in powder form.

54. The composition as claimed in one of claims 49 to 52, characterized in that it is in the form of an aqueous suspension.

55. The composition as claimed in claim 54, characterized in that the dry matter content of the suspension is from 20% to 50% by weight.

56. The composition as claimed in one of claims 49 to 55, characterized in that it is used in an amount representing from 0.5% to 5% of the weight of the cement.

57. The use of at least one phenolic derivative as claimed in one of claims 1 to 13, in a medium of the cement matrix, concrete or mortar type, as an agent for improving the fluidity of the paste, without entraining air.

58. The use of at least one phenolic derivative as claimed in one of claims 1 to 13, in a medium of the cement matrix, concrete or mortar type, as an agent for improving the mechanical properties of the concretes and mortars obtained.

59. The use of at least one phenolic derivative described in one of claims 1 to 13, in a leveling plastercoat, as an agent for reducing the amount of aluminous cement in the binary or ternary mixtures, while maintaining an acceptable open time, and improved mechanical properties.

60. The use of a phenolic derivative described in one of claims 1 to 13, in a medium of the cement matrix, concrete or mortar type, as an agent for improving the cohesion of said medium.

61. Cement matrices, concretes and mortars comprising at least one phenolic derivative described in one of claims 1 to 13.
